(19) United States
(12) Patent Application Publication
(10) Pub. No.: US 2006/0270391 A1
(43) Pub. Date: Nov. 30, 2006

(54) Method of providing location-based services in a mobile communication system

(75) Inventors: Jun-Hyung Kim, Suwon-si (KR); Geun-Hwi Lim, Sungnam-si (KR); Nae-Hyun Lim, Yongin-si (KR); Yong Chang, Sungnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/433,803

(22) Filed: May 12, 2006

(30) Foreign Application Priority Data
May 25, 2005 (KR) 10-2005-0043910

(51) Int. Cl. H04Q 7/38

(52) U.S. Cl. 455/414.1; 455/421; 455/456.1; 455/435.1

(57) ABSTRACT

A method of providing LBS (Location-Based Services) in a mobile communication system is provided. A Mobile Station (MS) entering an incoming call rejection service area is precluded from receiving incoming calls. When a call connection to the MS is requested, the call connection is blocked from the MS, and a call connection unavailable message is transmitted to a calling MS.

### PRIORITY

This application claims priority under 35 U.S.C. § 119 to an application entitled “Method of Providing Location-Based Services in a Mobile Communication System” filed in the Korean Intellectual Property Office on May 25, 2005 and assigned Serial No. 2005-43910, the contents of which are incorporated herein by reference.

### BACKGROUND OF THE INVENTION

1. Field of the Invention

The present invention relates generally to a mobile communication system, and in particular, to a method of providing Location-Based Services (LBS) therein.

2. Description of the Related Art

The on-going proliferation of mobile terminals has been realized from their ease of portability and the rapid development of mobile communication technology. The widespread use of mobile terminals is increasing the demand for various services beyond the traditional voice service and Short Message Service (SMS). At present, a variety of expanded services are being provided, such as wireless Internet, network games, and LBS.

LBS is an application system and service that accurately locates a person or an object over a mobile communication network and utilizes the location. LBS using a mobile terminal has evolved from positioning a mobile terminal on a base station (BS) basis, and is now used to locate a user more accurately with the aid of Global Positioning System (GPS) technology and to provide information, maps, and entertainment in relation to the location. This mobile terminal-based LBS improves convenience by providing rescue support in an emergency situation such as 911 or other emergency calls, tracking services, route guidance service, and traffic information service for informing of a current traffic condition.

However, it too often occurs that careless use of mobile terminals in public places such as classrooms, conference rooms, libraries, movie theatres, and public transportation vehicles causes disruption to others. This is particularly a problem in an environment requiring quietness such as classrooms and conference rooms, wherein the ringing tone of a mobile terminal may seriously disrupt a conference or class at a crucial point. Therefore, a user has to manually change the terminal to a quiet mode, or turn off the terminal before entering such an environment, to prevent this type of disruption. Yet, some users may forget to change their terminals to the quiet mode, and thus cause an unintended disturbance. Overall, having to manually set the operation mode of the mobile terminal is inconvenient.

### SUMMARY OF THE INVENTION

An object of the present invention is to substantially solve at least the above problems and/or disadvantages and to provide at least the advantages below. Accordingly, an object of the present invention is to provide a method of providing LBS in a mobile communication system.

Another object of the present invention is to provide a method of providing LBS, in which an LBS server blocks a call for a mobile terminal entering a predetermined area in a mobile communication system.

A further object of the present invention is to provide a method of registering a mobile terminal entering a predetermined area as rejected from incoming calls and thus blocking a call from the terminal by an LBS server in a mobile communication system.

The above objects are achieved by providing a method of providing LBS in a mobile communication system.

According to the present invention, in a method of providing LBS in a mobile communication system, a mobile station (MS) entering an incoming call rejection service area is prevented or restricted rejected from receiving incoming calls. When a call connection to the MS is requested, the call connection is blocked from the MS. A call connection unavailable message is transmitted to a calling MS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a mobile communication system according to the present invention;

FIG. 2 is a flowchart illustrating an operation for providing LBS in the mobile communication system according to the present invention;

FIG. 3 is a flowchart illustrating an operation for providing LBS in the mobile communication system according to a second embodiment of the present invention;

FIG. 4 is a flowchart illustrating an operation for providing LBS in the mobile communication system according to a third embodiment of the present invention;

FIG. 5 is a flowchart illustrating an operation for providing LBS in the mobile communication system according to a fourth embodiment of the present invention;

FIG. 6 is a diagram illustrating an overall signal flow in the mobile communication system according to the first embodiment of the present invention;

FIG. 7 is a diagram illustrating an overall signal flow in the mobile communication system according to the second embodiment of the present invention;

FIG. 8 is a diagram illustrating an overall signal flow in the mobile communication system according to the third embodiment of the present invention; and

FIG. 9 is a diagram illustrating an overall signal flow in the mobile communication system according to the fourth embodiment of the present invention.

### DETAILED DESCRIPTION OF THE PREFERRED EMBODIMENTS

Preferred embodiments of the present invention will be described herein below with reference to the accompanying drawings. In the following description, certain well-known functions or constructions are not described for the sake of clarity and conciseness.

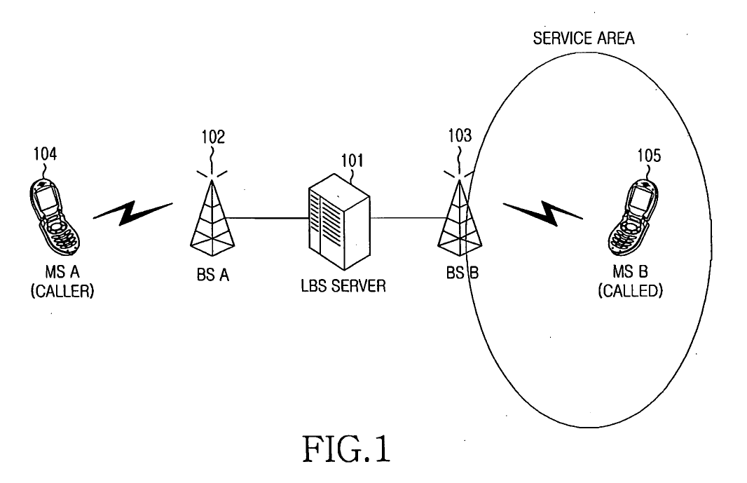

FIG. 1 illustrates the configuration of a mobile communication system according to the present invention.

Referring to FIG. 1, an LBS server 101 continuously stores/manages location information received from a location information access gateway in a communication network, and provides additional functions required for LBS. In addition to the typical functions, the LBS server 101 sets an area within a particular BS (e.g. a BS 103) as an incoming call rejection service area upon request of an operator, and when needed, sets a service period for the incoming call rejection, as well. When a Mobile Station (MS) entering the incoming call rejection service area (e.g. an MS 105), the incoming call rejection service is provided to the MS for the service period.

BSs 102 and 103 (BS A and BS B) transmit signals received wirelessly from MSs 104 and 105 (MS A and MS B) within their coverage to a Mobile Switching Center (MSC) and transmit signals received wirelessly from the MSC to the MSs 104 and 105. The MSs 104 and 105 are the terminals of mobile subscribers roaming within the services areas and communicate with the BSs 102 and 103 on radio channels.

In an LBS providing procedure according to the present invention, when the calling MS 104 calls the MS 105, the call is not connected to the MS 105 because the MS 105 is in the service area of the BS 103 designated to reject incoming calls. The MS 104 receives a message indicating that the call is unavailable because the MS 105 is in an incoming call rejection mode.

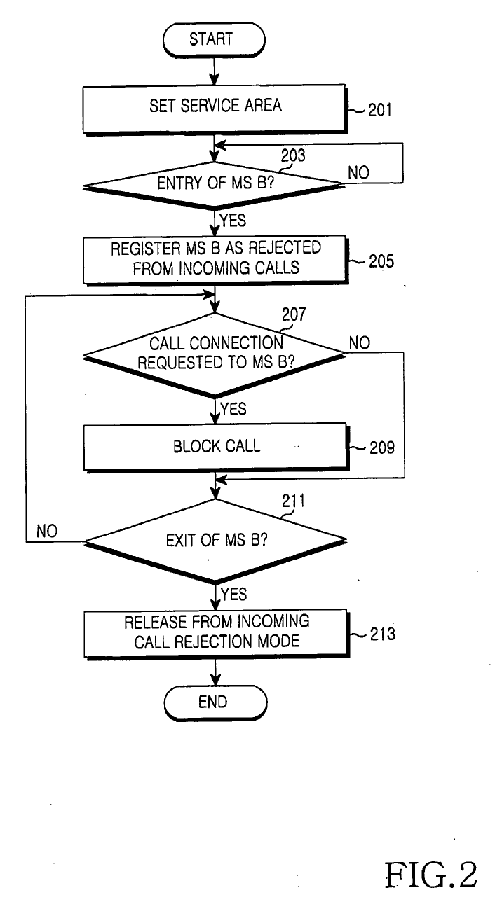

FIG. 2 is a flowchart illustrating an operation for providing LBS in the mobile communication system according to the present invention.

Referring to FIG. 2, an LBS server 101 designates or sets a part of the service area of the BS 103 as an incoming call rejection service area in step 201, and monitors whether there is any MS entering the incoming call rejection service area in step 203. If the LBS server 101 detects the MS 105 entering the incoming call rejection service area, it stores information about the MS 105 in its database, thereby registering the MS 105 as rejected from incoming calls in step 205. The LBS server 101 may inform the MS 105 that the MS 105 has been registered as rejected from incoming calls by an incoming call rejection message. This incoming call rejection message can indicate that the call is not unavailable due to the called MS 105 being in an incoming call rejection service area. Simultaneously, vibrations or a flashing lamp can be provided to alert the user of the MS 105 to the message reception.

In step 207, the LBS server 101 monitors whether the MS 104 has requested a call connection to the MS 105. In the absence of the call connection request, the LBS server 101 determines whether the MS 105 is out of the incoming call rejection service area in step 211. On the other hand, in the presence of the call connection request, the LBS server 101 informs the MS 104 that the call is unavailable to the MS 105 by a text message, while blocking the call from the MS 105 in step 209. At the same time, the LBS server 101 can also inform the MS 105 of the incoming of the call connection request by transmitting details of the incoming call in a text message. The text message transmitted to the MS 104 may include information indicating the call connection is unavailable due to the called MS being in the incoming call rejection service area and information indicating an expected end time of the incoming call rejection service.

In step 211, the LBS server 101 monitors whether the MS 105 is out of the incoming call rejection service area. If the MS 105 is still in the incoming call rejection service area, the LBS server 101 returns to step 207. If the MS 105 is out of the incoming call rejection service area, the LBS server 101 deletes the information of the MS 105 from the database, thereby releasing the MS 105 from the incoming call rejection mode in step 213 and terminates this algorithm. At the same time, the LBS server 101 can inform both the MS 104 and the MS 105 of the release of the MS 105 from the incoming call rejection mode. While it has been described that the incoming call rejection service is provided to any MS entering a particular service area irrespective of time, the incoming call rejection service can be limited by setting an incoming call rejection service period. In this case, the LBS server 101 releases the MS 105 from the incoming call rejection mode when it is out of the incoming call rejection service area or when the incoming call rejection service period has expired.

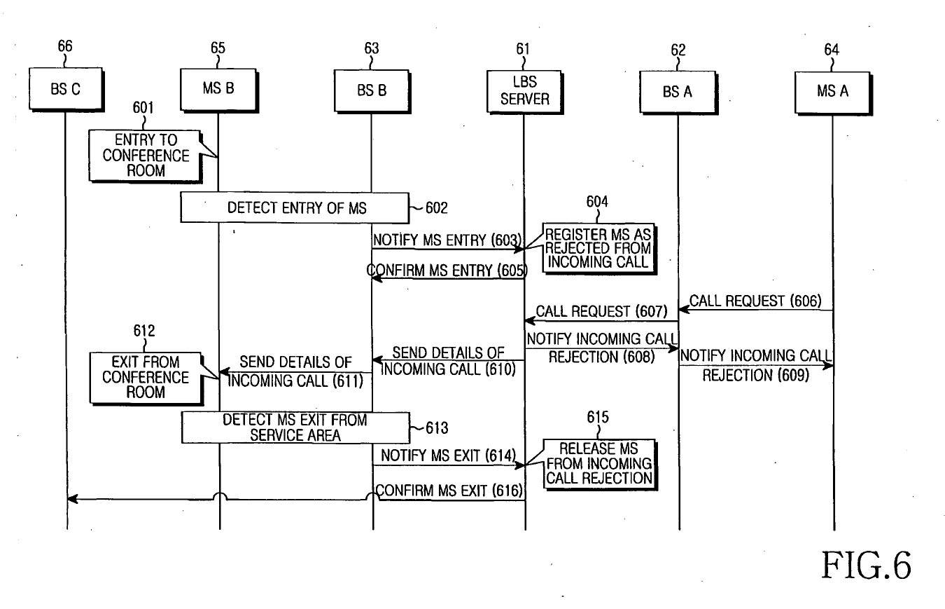

FIG. 6 is a diagram illustrating an overall signal flow in the mobile communication system according to the first embodiment of the present invention.

Referring to FIG. 6, an LBS server 61 sets an area within the coverage of a BS 63 (BS B) as an incoming call rejection service area and monitors whether any MS enters the incoming call rejection service area, for example, a conference room. When an MS 65 (MS B) enters the conference room in step 601, the BS 63 detects the entry of the MS 65 in step 602 and informs the LBS server of the entry of the MS 65 to the conference room by an MS entry notification message in step 603. In step 604, the LBS server 61 registers the MS 65 as rejected from incoming calls in its database, and transmits an MS entry confirm message to the BS 63 in step 605.

When an MS 64 (MS A) transmits a call request message to its serving BS 62 (BS A) in step 606, for a call with the MS 65, the BS 62 forwards the call request message to the LBS server 61 to query whether a call connection to the MS 65 is possible in step 607. Upon receipt of the call request message, the LBS server 61 determines that the MS 65 cannot receive an incoming call by referring to the database, and blocks the incoming call from the MS 65. In steps 608 and 609, the LBS server 61 informs the MS 64 that the call connection to the MS 65 is unavailable through the BS 62 by a text message. The LBS server 61 also informs the MS 65 of the presence of the call connection request through the BS 63 by a text message in steps 610 and 611. The text message transmitted to the calling MS 64 may contain information indicating the call connection is unavailable in the current incoming call rejection service area and information indicating an expected end time of the incoming call rejection service.

If the MS 65 exits from the conference room in step 612, the BS 63 detects the MS 65 out of the incoming call rejection service area in step 613 and transmits an MS exit notification message to the LBS server 61 in step 614. In step 615, the LBS server 61 then deletes the information of the MS 65 from the database and releases the MS 65 from the incoming call rejection mode. The LBS server 61 transmits an exit confirm message to a new serving BS 66 (BS C) for the MS 65, thereby informing that the incoming call rejection service is ended for the MS 65 in step 616. A service time period as well as the incoming call rejection service area can be set. If the service termination for the MS 65 is triggered by the expiration of the service time period, instead of the MS 65 being out of the incoming call rejection service area, the LBS server 61 releases the MS 65 from the incoming call rejection mode in step 615 without performing steps 612, 613 and 614 and then informs the BS 66 of the service termination for the MS 65 in step 616.

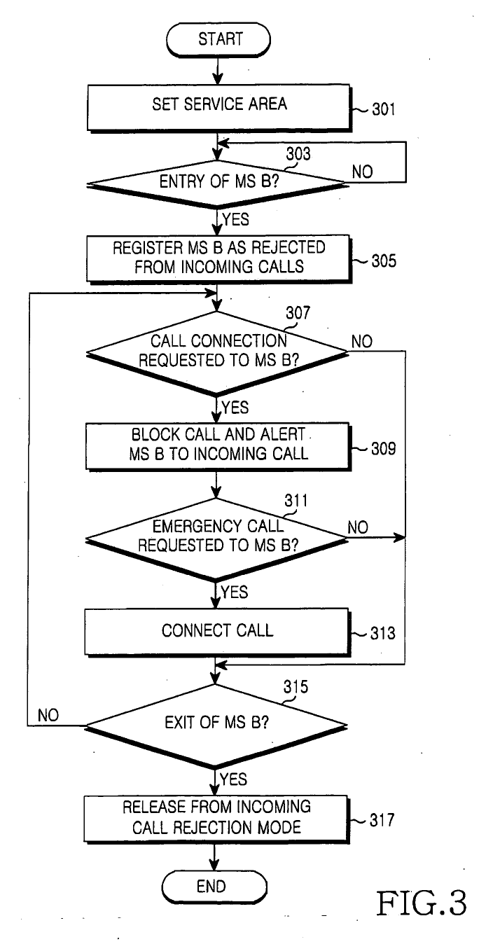

FIG. 3 is a flowchart illustrating an operation for providing LBS in the mobile communication system according to a second embodiment of the present invention.

Referring to FIG. 3, the LBS server 101 sets a part of the service area of the BS 103 as an incoming call rejection service area in step 301 and monitors whether there is any MS entering the incoming call rejection service area in step 303. If the LBS server 101 detects the MS 105 entering the incoming call rejection service area, it registers the MS 105 as rejected from incoming calls in step 305. The LBS server 101 may inform the user of the MS 105 that the MS 105 has been registered as rejected from incoming calls by a text message. Simultaneously, vibrations or a flashing lamp can be provided to alert the user to the message reception.

In step 307, the LBS server 101 monitors whether the MS 104 has requested a call connection to the MS 105. In the absence of the call connection request, the LBS server 101 determines whether the MS 105 is out of the incoming call rejection service area in step 311. On the other hand, in the presence of the call connection request, the LBS server 101 informs the MS 104 that the call is unavailable to the MS 105 by a text message, while blocking the call from the MS 105 in step 309. The message transmitted to the calling MS 104 may include information indicating that the call connection is unavailable due to the MS 105 being in the incoming call rejection service area and information indicating an expected end time of the incoming call rejection service. At the same time, the LBS server 1001 can also inform the MS 105 of the incoming of the call connection request by transmitting details of the incoming call in a text message. This text message can provide the name and phone number of the caller and the time of the call.

In step 311, the LBS server 101 monitors whether the MS 104 has requested an emergency call to the MS 105. Although the calling MS 104 was informed that the call connection is unavailable to the MS 105, it can request an emergence call when needed. Then the MS 104 can make a call with the MS 105 normally. In the absence of the emergency call request, the LBS server 101 monitors whether the MS 105 is out of the incoming call rejection service area in step 315. In the presence of the emergency call request, the LBS server 101 connects the call to the MS 105 and informs the MS 105 of the emergency call request in step 313. The MS 105 is alerted to the emergency call without ringing, for example, by setting the operation mode of the MS 105 to a vibration or flashing lamp mode.

In step 315, the LBS server 101 monitors whether the MS 105 is out of the incoming call rejection service area. If the MS 105 is still in the incoming call rejection service area, the LBS server 101 returns to step 307. If the MS 105 is out of the incoming call rejection service area, the LBS server 101 deletes the information of the MS 105 from the database, thereby releasing the MS 105 from the incoming call rejection mode in step 317 and terminates this algorithm. At the same time, the LBS server 101 can inform both the MS 104 and the MS 105 of the release of the MS 105 from the incoming call rejection mode. Along with the message reception, the MS 105 vibrates or flashes a lamp to alert the user to the message reception.

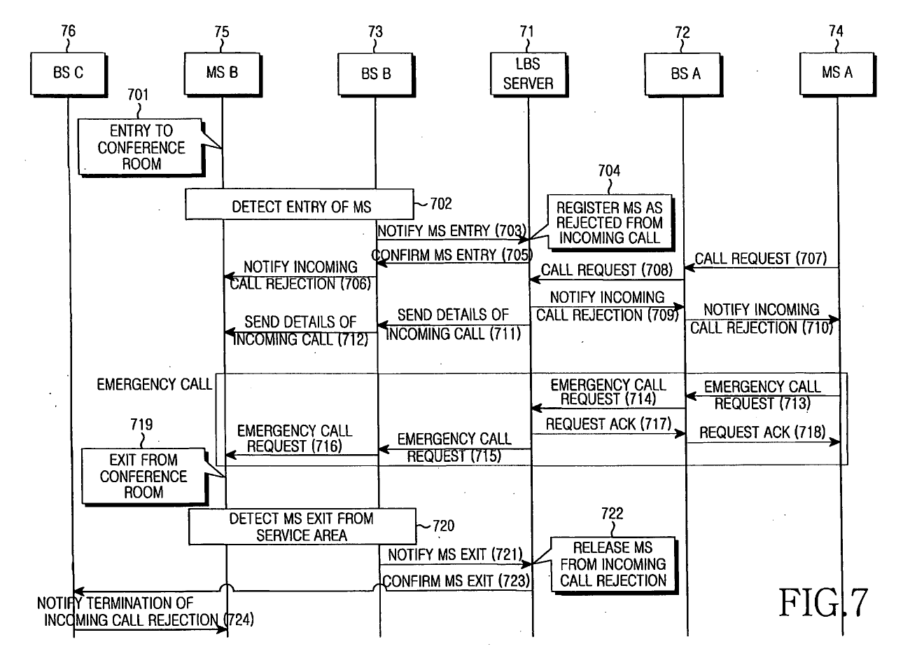

FIG. 7 is a diagram illustrating an overall signal flow in the mobile communication system according to the second embodiment of the present invention.

Referring to FIG. 7, an MS 75 (MS B) enters a conference room set as an incoming call rejection service area in step 701. The conference room is within the service area of a BS 73 (BS B) to which an incoming call rejection service is provided according to the present invention. The BS 73 detects the entry of the MS 75 in step 702 and informs an LBS server 71 of the entry of the MS 75 in step 703. In step 704, the LBS server 71 registers the MS 75 as rejected from incoming calls in its database, and informs the BS 73 that the entry of the MS 75 is confirmed in step 705. The BS 73 notifies the MS 75 that the MS 75 will operate in the incoming call rejection mode in step 706.

When a calling MS 74 (MS A) transmits a call request message to the LBS server 71 via a BS 72 (BS A) in steps 707 and 708, the LBS server 71 finds out that the MS 75 is in the incoming call rejection service area by referring to the data base, and blocks the incoming call from the MS 75. In step 709, the LBS server 71 informs the BS 72 that since the MS 75 operates in the incoming call rejection mode, the call connection is unavailable. The BS 72 notifies the MS 74 of the call being unavailable in step 710. The LBS server 71 also informs the MS 75 of the presence of the call connection request through the BS 73 in steps 711 and 712.

When needed, the calling MS 74 can request an emergency call. Upon receipt of an emergency call request message from the MS 74 in step 713, the BS 72 forwards the emergency call request message to the LBS server 71 in step 714. The LBS server 71 connects the call and forwards the emergency call request message to the MS 75 via the BS 73 in steps 715 and 716. In steps 717 and 718, the LBS server 71 transmits a request acknowledgement (Ack) message to the MS 74 via the BS 72. Thus, the emergency call is made.

If the MS 75 exits from the conference room in step 719, the BS 73 detects the exit of the MS 75 from the incoming call rejection service area in step 720 and transmits an MS exit notification message to the LBS server 71 in step 721. In step 722, the LBS server 71 then deletes the information of the MS 75 from the database and releases the MS 75 from the incoming call rejection mode. The LBS server 71 transmits an exit confirm message to a new serving BS 76 (BS C) for the MS 75 in step 723. The BS 76 transmits an incoming call rejection service end message to the MS 75 in step 724. A service time period as well as the incoming call rejection service area can be set. If the MS 705 moves out of the incoming call rejection service area during the incoming call rejection service or the service time period expires, the LBS server 71 releases the MS 75 from the incoming call rejection mode. For example, if a set conference time expires while the MS 75 stays in the conference room, the LBS server 71 deletes the information of the MS 75 from the database and notifies the MS 75 of termination of the incoming call rejection service.

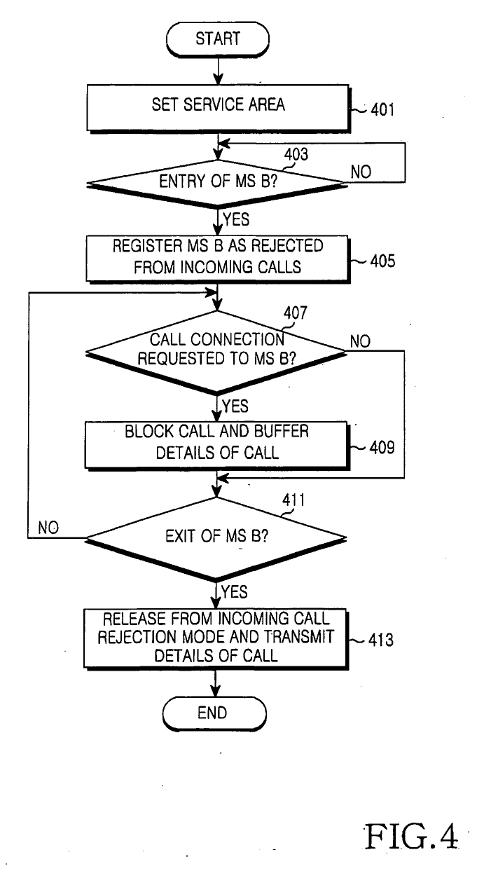

FIG. 4 is a flowchart illustrating an operation for providing LBS in the mobile communication system according to a third embodiment of the present invention.

Referring to FIG. 4, the LBS server 101 sets a part of the service area of the BS 103 as an incoming call rejection service area in step 401 and monitors whether there is any MS entering the incoming call rejection service area in step 403. If the LBS server 101 detects the MS 105 entering the incoming call rejection service area, it registers the MS 105 as rejected from incoming calls, to thereby block incoming calls from the MS 105 in step 405. The LBS server 101 may inform the MS 105 that any incoming call will be rejected.

In step 407, the LBS server 101 monitors whether the MS 104 has requested a call connection to the MS 105. In the absence of the call connection request, the LBS server 101 determines whether the MS 105 is out of the incoming call rejection service area in step 411. On the other hand, in the presence of the call connection request, the LBS server 101 blocks the call from the MS 105 and stores details of the incoming call in the database until the incoming call rejection service ends, so as not to disturb the conference in step 409. At the same time, the LBS server 101 informs the MS 104 that the call is unavailable to the MS 105.

In step 411, the LBS server 101 monitors whether the MS 105 is out of the incoming call rejection service area. If the MS 105 is still in the incoming call rejection service area, the LBS server 101 returns to step 407. If the MS 105 is out of the incoming call rejection service area, the LBS server 101 deletes the information of the MS 105 from the database, thereby releasing the MS 105 from the incoming call rejection mode in step 413. At the same time, the LBS server 101 informs the user of the MS 105 of the termination of the incoming call rejection service, transmits details of incoming calls for the service time period to the user, and ends the algorithm. The details of incoming calls can be the names and phone numbers of callers, the times of the calls, and the number of the calls. The MS 105 may vibrate or flash a lamp to alert the user to the message reception.

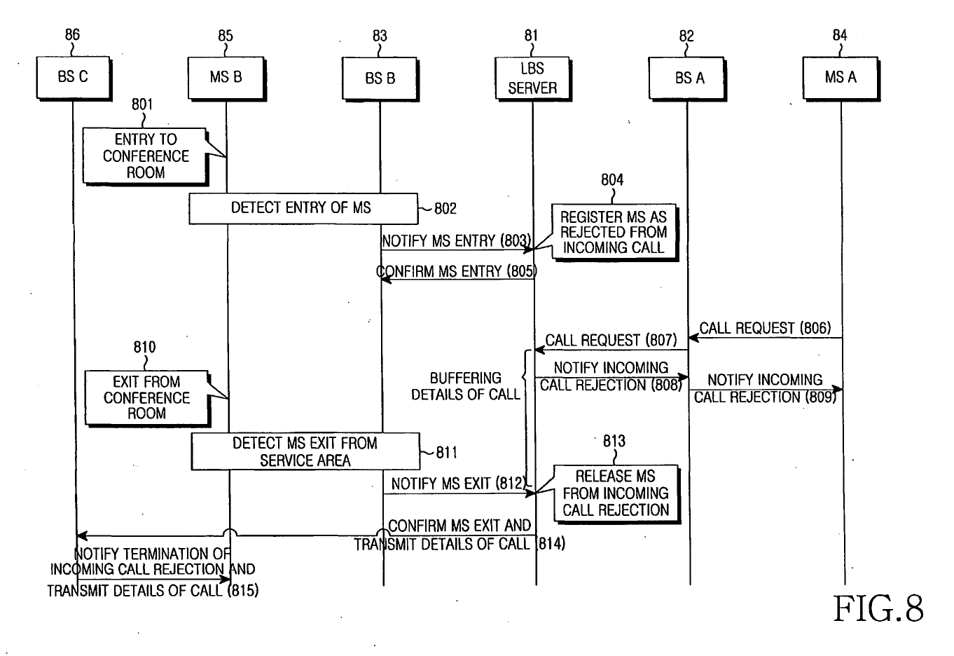

FIG. 8 is a diagram illustrating an overall signal flow in the mobile communication system according to the third embodiment of the present invention.

Referring to FIG. 8, an LBS server 81 sets a part of the service area of a BS 83 (BS B) as an incoming call rejection service area and monitors whether any MS enters the incoming call rejection service area, for example, a conference room. If an MS 85 (MS B) enters the conference room in step 801, the BS 83 detects the entry of the MS 85 in step 802 and informs the LBS server 81 of the entry of the MS 85 in step 803. In step 804, the LBS server 81 registers the MS 85 as rejected from incoming calls, and transmits an MS entry confirm message to the BS 83 in step 805. The BS 83 can notify the user of the MS 85 that the MS 85 has been registered as rejected from incoming calls by a text message.

When a calling MS 84 (MS A) served by a BS 82 (BS A) transmits a call request message for a call with the MS 85 to the BS 82 in step 806, the BS 82 forwards the call request message to the LBS server 81 in step 807. The LBS server 81 finds out that the call cannot be connected to the MS 85 by referring to the database, and blocks the call from the MS 85. In steps 808 and 809, the LBS server 81 informs the MS 84 of the call connection being unavailable via the BS 82. Notably, the LBS server 81 stores details of the incoming call in the database until the end of the incoming call rejection service without informing the MS 85 of the call request from the MS 84, so as not to disturb the conference.

If the MS 85 exits from the conference room in step 810, the BS 83 detects the exit of the MS 85 from the incoming call rejection service area in step 811 and notifies the LBS server 81 of the exit of the MS 85 from the conference room in step 812. In step 813, the LBS server 81 then releases the MS 85 from the incoming call rejection mode. The LBS server 81 transmits an exit confirm message to a new serving BS 86 (BS C) for the MS 85, notifying of the termination of the incoming call rejection mode in step 814. Simultaneously, details of incoming calls received for a service time period are provided to the BS 86. The BS 86 transmits an incoming call rejection mode termination message and information about the incoming calls for the service time period to the MS 85 in step 815 and ends this algorithm. At the same time, the MS 84 can be notified of the termination of the incoming call rejection service for the MS 85. If the service termination for the MS 85 is triggered by the expiration of the service time period, instead of the MS 85 being out of the incoming call rejection service area, the LBS server 81 informs the MS 85 of the service termination via the BS 83.

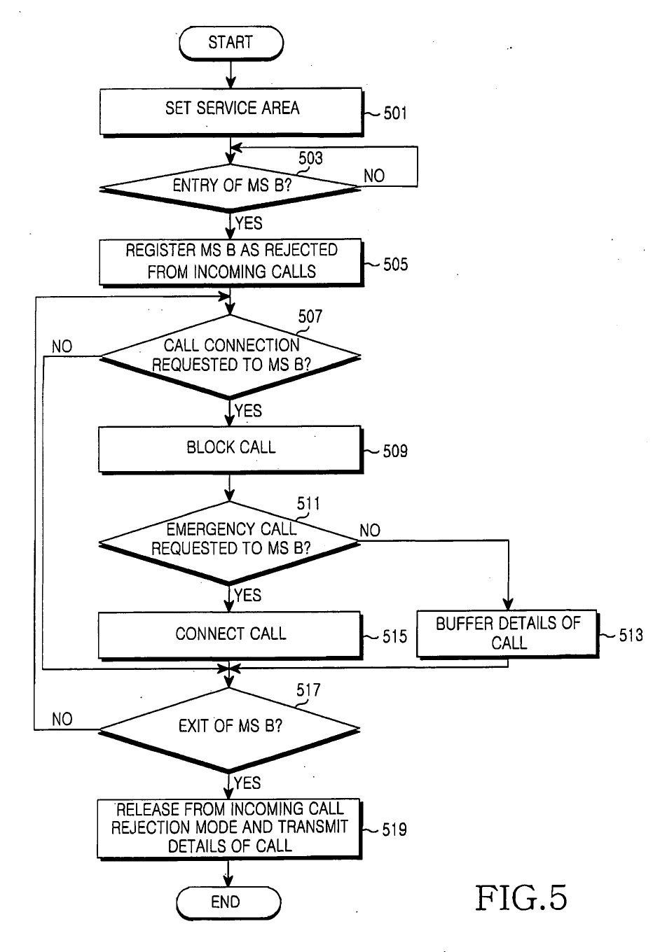

FIG. 5 is a flowchart illustrating an operation for providing LBS in the mobile communication system according to a fourth embodiment of the present invention.

Referring to FIG. 5, the LBS server 101 sets a part of the service area of the BS 103 as an incoming call rejection service area in step 501 and monitors whether there is any MS entering the incoming call rejection service area in step 503. If the LBS server 101 detects the MS 105 entering the incoming call rejection service area, it registers the MS 105 as rejected from incoming calls in step 505. The LBS server 101 may inform the user of the MS 105 that the MS 105 has entered the incoming call rejection service area by an incoming call rejection message.

In step 507, the LBS server 101 monitors whether the MS 104 has requested a call connection to the MS 105. In the absence of the call connection request, the LBS server 101 determines whether the MS 105 is out of the incoming call rejection service area in step 517. On the other hand, in the presence of the call connection request, the LBS server 101 blocks the call from the MS 105 in step 509. At the same time, the LBS server 101 notifies the MS 104 that the call connection is unavailable because the incoming call rejection service is ongoing for the MS 105, but an emergency call can be made when necessary.

In step 511, the LBS server 101 monitors whether the MS 104 has requested an emergency call to the MS 105. In the absence of the emergency call request, the LBS server 101 buffers details of the incoming call until the end of the incoming call rejection service in the database in step 513. In the presence of the emergency call request, the LBS server 101 connects the emergency call to the MS 105 and informs the MS 105 of the emergency call request in step 515.

In step 517, the LBS server 101 monitors whether the MS 105 is out of the incoming call rejection service area. If the MS 105 is still in the incoming call rejection service area, the LBS server 101 returns to step 507. If the MS 105 is out of the incoming call rejection service area, the LBS server 101 releases the MS 105 from the incoming call rejection mode by deleting the information of the MS 105 from the database, and transmits the details of incoming calls received during a service time period to the user of the MS 105 in step 519 and terminates this algorithm. At the same time, the LBS server 101 can inform the MS 104 of the exit of the MS 105 from the incoming call rejection service area.

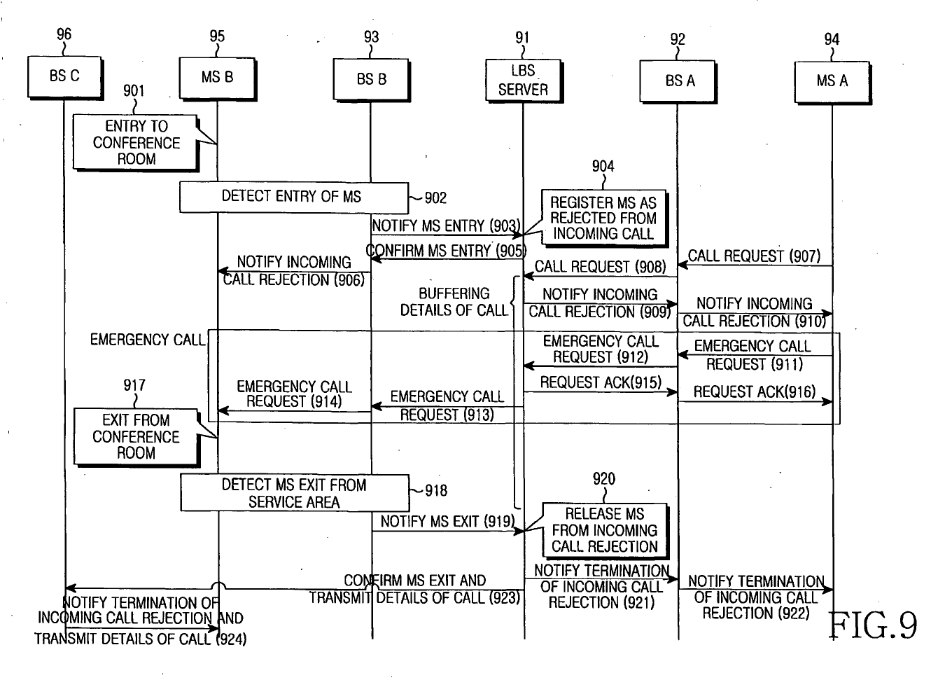

FIG. 9 is a diagram illustrating an overall signal flow in the mobile communication system according to the fourth embodiment of the present invention.

Referring to FIG. 9, an MS 95 (MS B) enters a conference room set as an incoming call rejection service area in step 901. The BS 93 detects the entry of the MS 95 in step 902 and transmits an MS entry notification message to an LBS server 91, notifying of the entry of the MS 95 in step 903. In step 904, the LBS server 91 registers the MS 95 as rejected from incoming calls, and transmits an MS entry confirm message to the BS 93 in step 905. The BS 93 notifies the MS 95 that the MS 95 cannot receive any incoming call in step 906.

When a calling MS 94 (MS A) transmits a call request message to the LBS server 91 via its serving BS 92 (BS A) in steps 907 and 908, the LBS server 91 finds out that the MS 95 is in the incoming call rejection service area by referring to the data base, and blocks the incoming call from the MS 95. In steps 909 and 910, the LBS server 91 informs the MS 94 that the call connection is unavailable and when necessary, an emergency call can be requested via the BS 92.

While receiving a notification message indicating that the MS 95 is in a quiet mode in step 910, the calling MS 94 can request an emergency call to the BS 92 when needed, as stated above. Upon receipt of an emergency call request message from the MS 94 via the BS 92 in steps 911 and 912, the LBS server 91 connects the call and forwards the emergency call request message to the MS 95 via the BS 93 in steps 913 and 914. In steps 915 and 916, the LBS server 91 transmits a request Ack message to the MS 94 via the BS 92. For an MS that has requested a non-emergency call, the details of the call are stored in the database until the end of the service time period.

If the MS 95 exits from the conference room in step 917, the BS 93 detects the exit of the MS 95 from the incoming call rejection service area in step 918 and transmits an MS exit notification message to the LBS server 91 in step 919. In step 920, the LBS server 91 then deletes the information of the MS 95 from the database and releases the MS 95 from the incoming call rejection mode. The LBS server 91 can notify the MS 94 via the BS 92 that the incoming call rejection service of the MS 95 has been terminated in steps 921 and 922. In step 923, the LBS server 91 transmits an exit confirm message to a new serving BS 96 (BS C) for the MS 95, along with the details of the incoming calls stored in the database during the service time period. The BS 96 transmits an incoming call rejection service end message and the details of the incoming calls to the MS 95 in step 924 and ends the algorithm. The service time period can be set along with setting of the incoming call rejection service area. If the service termination for the MS 95 is triggered by the expiration of the service time period, instead of the MS 95 being out of the incoming call rejection service area, the LBS server 91 notifies the MS 95 of the end of the incoming call rejection service and transmits the details of the incoming calls.

In accordance with the present invention, in an LBS system, a call connection is blocked from an MS entering a set area, thereby preventing disturbing use of a mobile terminal by a user in a specific place or at a specific time requiring quietness and a refrain from disruption to others. Furthermore, since there is no need for setting a quiet mode manually, mobile users can use their mobile terminals more conveniently.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of providing location-based services (LBS) in a mobile communication system, comprising the steps of:
registering a mobile station (MS) entering an incoming call rejection service area; and
blocking a call to the MS, when a call connection to the MS is requested, and transmitting a call connection unavailable message to a calling MS.

2. The method of claim 1, further comprising informing the MS that incoming calls are rejected for the MS.

3. The method of claim 1, further comprising connecting an emergency call to the MS when the calling MS requests the emergency call to the MS after transmitting the call connection unavailable message.

4. The method of claim 1, further comprising transmitting details of the incoming call to the MS, when the call connection unavailable message is transmitted.

5. The method of claim 1, further comprising buffering details of the incoming call, when the call connection unavailable message is transmitted.

6. The method of claim 5, further comprising ending an incoming call rejection service and transmitting the details of the incoming call to the MS, when the MS is out of the incoming call rejection service area.

7. The method of claim 1, further comprising terminating an incoming call rejection service, when the MS is out of the incoming call rejection service area.

8. The method of claim 7, further comprising notifying the calling MS of the termination of the incoming call rejection service, when the incoming call rejection service is terminated.

9. The method of claim 7, further comprising notifying the MS of the termination of the incoming call rejection service, when the incoming call rejection service is ended.

10. A method of providing location-based services (LBS) in a mobile communication system, comprising the steps of:
registering a mobile station (MS) entering an incoming call rejection service area during a service time period; and
blocking a call for the MS, when a call connection to the MS is requested, and transmitting a call connection unavailable message to a calling MS.

11. The method of claim 10, further comprising informing the MS that incoming calls are rejected for the MS.

12. The method of claim 10, further comprising connecting an emergency call to the MS, when the calling MS requests the emergency call with the MS after transmitting the call connection unavailable message.

13. The method of claim 10, further comprising transmitting details of the incoming call to the MS, when the call connection unavailable message is transmitted.

14. The method of claim 10, further comprising buffering details of the incoming call, when the call connection unavailable message is transmitted.

15. The method of claim 14, further comprising terminating an incoming call rejection service and transmitting the details of the incoming call to the MS, when the MS is out of the set incoming call rejection service area.

16. The method of claim 10, further comprising terminating an incoming call rejection service, when the MS is out of the incoming call rejection service area or the service time period expires.

17. The method of claim 16, further comprising notifying the calling MS of the termination of the incoming call rejection service, when the incoming call rejection service is terminated.

18. The method of claim 16, further comprising notifying the MS of the termination of the incoming call rejection service, when the incoming call rejection service is terminated.

19. A method of providing a call rejection service in a mobile communication system, comprising the steps of:
blocking a call for a registered mobile station (MS) in a call rejection service area; and
transmitting a call connection unavailable message to a calling MS.

20. A method of providing a call rejection service in a mobile communication system, comprising the steps of:
blocking a call for a registered mobile station (MS) in a call rejection service area during a service time period; and
transmitting a call connection unavailable message to a calling MS.
